(19) United States
(12) Patent Application Publication
(10) Pub. No.: US 2006/0023169 A1
(43) Pub. Date: Feb. 2, 2006

(54) Projection television

(76) Inventor: Sung-soo Jung, Suwon-si (KR)

Correspondence Address: STANZIONE & KIM, LLP, 919 18TH STREET, N.W., SUITE 440, WASHINGTON, DC, 20006, US

(21) Appl. No.: 11/181,727

(22) Filed: Jul. 15, 2005

(30) Foreign Application Priority Data
Jul. 30, 2004 (KR) 2004-60129

(51) Int. Cl. G03B 21/28

(52) U.S. Cl. 353/78

(57) ABSTRACT

A projection television includes a screen, a casing to support the screen, an optical engine coupled to the casing to project an image beam, a first reflecting mirror provided in a rear side of the screen so as to reflect the image beam projected from the optical engine, and a second reflecting mirror provided above the first reflecting mirror so as to reflect the image beam reflected from the first reflecting mirror toward the screen. The projection television has a decreased height and a simple configuration to facilitate manufacturing of the same.

### CROSS-REFERENCE TO RELATED APPLICATIONS

This application claims the benefit of Korean Patent Application No. 2004-60129, filed on Jul. 30, 2004, in the Korean Intellectual Property Office, the disclosure of which is incorporated herein by reference.

### BACKGROUND OF THE INVENTION

1. Field of the Invention

The present general inventive concept relates to a projection television, and more particularly, to a projection television comprising an improvement in a path of an image beam projected from an optical engine to a screen.

2. Description of the Related Art

Generally, a projection television projects an image beam to a rear side of a screen through an optical apparatus to display an image.

The projection television comprises a casing; an optical engine mounted in the casing and projecting the image beam; a reflecting mirror provided in a rear portion of the casing and reflecting the image beam projected from the optical engine; and a screen provided in a front portion of the casing and displaying the image by the image beam.

The projection television has a merit of easily displaying an enlarged image, and thus tends to be widely used.

The optical engine projects the image beam toward the screen through the reflecting mirror, and is classified into a CRT (Cathode Ray Tube) type, an LCD (Liquid Crystal Display) type, a DLP (Digital Light Processing) type, etc. Hereinafter, the following description will be given with regard to the projection television including the optical engine of the CRT type by way of an example.

FIG. 1 is an exploded perspective view schematically illustrating a conventional projection television 101. As shown in FIG. 1, the conventional projection television 101 comprises a screen 103 displaying an image; a front casing 111 supporting the screen 103 and having an opening 112 to expose the screen 103; a rear casing 113 provided in a rear side of the front casing 111; a reflecting mirror 107 provided at an inside of the rear casing 113; an optical engine 120 provided between the front casing 11 and the rear casing 113 and projecting an image beam toward the reflecting mirror 107; and a circuit 130 provided under the optical engine 120 and operating the optical engine 120, etc.

The optical engine 120 is provided in an upward and backward direction to face the reflecting mirror 107 so as to project the image beam to the reflecting mirror 107, and is supported by an engine bracket 121. The optical engine 120 projects the image beam toward the reflecting mirror 107, and the projected image beam is reflected frontward by the reflecting mirror 107 so that the image is displayed on the screen 103.

However, as shown in FIG. 1, the optical engine 120 stands in an almost upright position in the conventional projection television, so that the front casing and the rear casing are high to correspond to the length of the optical engine, and a volume of the projection television is increased.

An optical projection engine for a monitor is disclosed in Korean patent first publication No. 2002-0016413, which improves trouble that the volume of the projection television is increased, etc. The monitor including the optical projection engine comprises three sheets of reflecting mirrors so that a thickness and a volume thereof are decreased. The three sheets of reflecting mirrors are respectively positioned under a screen, behind the screen, and rear the screen in the casing. The optical projection engine is provided frontward so as to project an image beam toward the reflecting mirrors provided under the screen.

With this configuration, the optical projection engine projects the image beam toward the reflecting mirror disposed under the screen, the projected image beam is reflected toward the reflecting mirror provided upper behind the screen, the reflected image beam is repeatedly reflected toward the reflecting mirror provided in rear of the screen, and then the reflected image beam is reflected frontward and displays the image on the screen.

The monitor including the optical projection engine becomes relatively slim as compared with the monitor of the conventional projection television illustrated in FIG. 1. However, because the reflecting mirror thereof is provided under the screen, a height thereof may be not sufficiently reduced. Moreover, manufacturing of the projection television may become difficult because the optical projection engine is provided frontward, which is different from a direction of the conventional optical engine, and the arrangement of the reflecting mirrors in the monitor becomes complicated.

### SUMMARY OF THE INVENTION

Accordingly, the present general inventive concept provides a projection television comprising a decreased height and a simple configuration to facilitate manufacturing of the same.

Additional aspects and/or advantages of the general inventive concept will be set forth in part in the description which follows and, in part, will be obvious from the description, or may be learned by practice of the invention.

The foregoing and/or other aspects and advantages of the present general inventive concept are achieved by providing a projection television comprising a screen, a casing to support the screen; an optical engine coupled to the casing and projecting an image beam, a first reflecting mirror provided in a rear side of the screen so as to reflect the image beam projected from the optical engine, and a second reflecting mirror provided above the first reflecting mirror so as to reflect the image beam reflected from the first reflecting mirror toward the screen.

The casing may comprise a front casing to support the screen and a rear casing provided in a rear side of the first casing, and the first reflecting mirror may be provided at a lower portion of the rear casing while the second reflecting mirror is provided at an upper portion of the rear casing.

The first reflecting mirror may be smaller in size than the second reflecting mirror, may be shaped like a plate, and may be inclined such that a lower portion thereof is projected frontward.

The projection television any further comprise an engine bracket to support the optical engine such that the optical engine is inclined upward and backward to project the image beam toward the first reflecting mirror.

### BRIEF DESCRIPTION OF THE DRAWINGS

These and other aspects and advantages of the general inventive concept will become apparent and more readily appreciated from the following description of the embodiments, taken in conjunction with the accompany drawings of which:

FIG. 1 is an exploded perspective view schematically illustrating a conventional projection television;

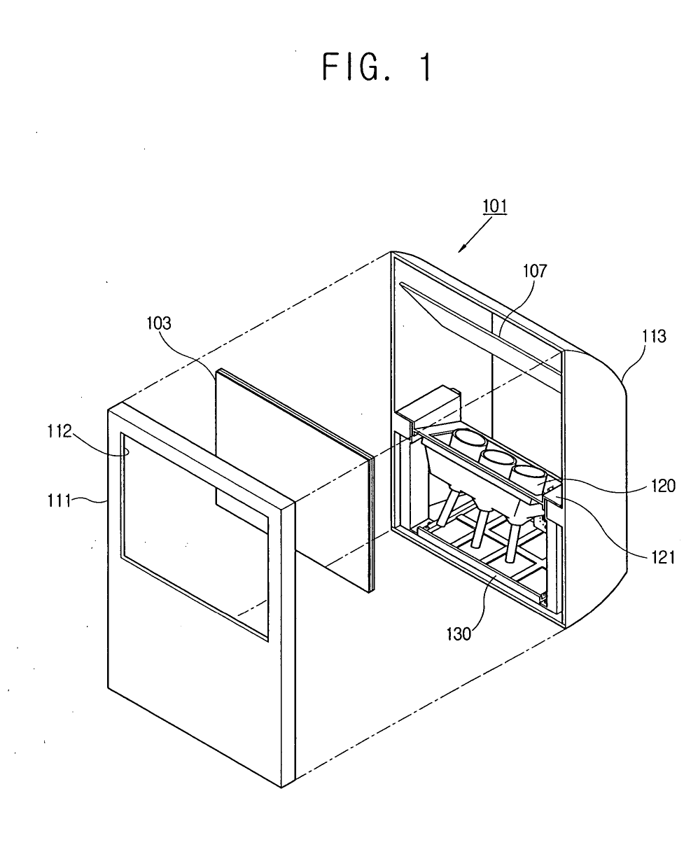

FIG. 2 is a perspective view of a projection television according to an embodiment of the present general inventive concept;

FIG. 3 is an exploded perspective view of the projection television of FIG. 2; and

FIG. 4 is a sectional view of the projection television of FIG. 2.

### DETAILED DESCRIPTION OF THE PREFERRED EMBODIMENTS

Reference will now be made in detail to an embodiment of the present general inventive concept, examples of which are illustrated in the accompanying drawings, wherein like reference numerals refer to like elements throughout. The embodiment is described below in order to explain the present general inventive concept by referring to the figures.

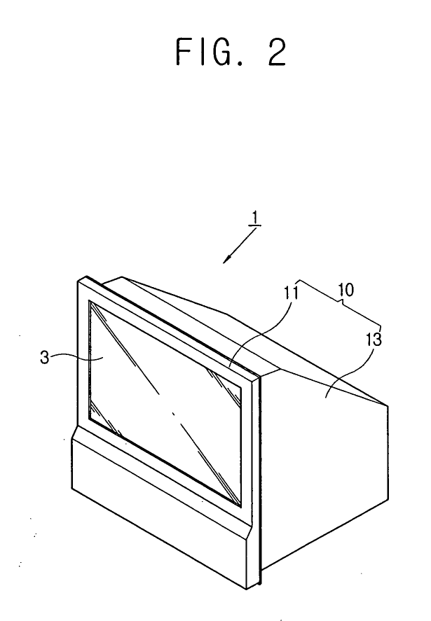

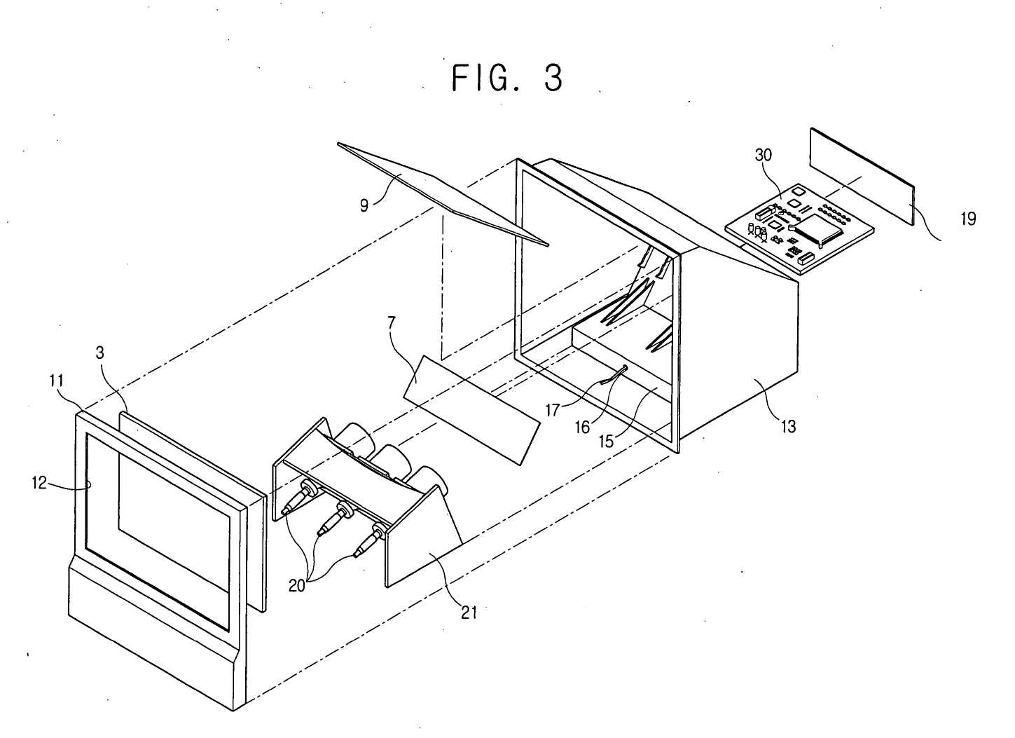

As shown in FIGS. 2 through 4, a projection television 1 according to an embodiment of the present general inventive concept comprises a screen 3 to display an image, a casing 10 to support the screen 3, an optical engine 20 provided in the casing 10 to project an image beam, a first reflecting mirror 7 provided in a rear side of the screen 3 so as to reflect the image beam projected from the optical engine 20, and a second reflecting mirror 9 provided above first reflecting mirror 7 so as to reflect the image beam reflected from the first reflecting mirror 7 toward the screen 3. The projection television 1 may further comprise a circuit 30 to operate the optical engine 20, etc.

The optical engine 20 is provided at a lower portion of an inner space formed in the casing 10 and projects the image beam toward the first reflecting mirror 7. The optical engine 20 is supported by an engine bracket 21 so as to project the image beam toward the first reflecting beam 7. The engine bracket 21 supports the optical engine 20 to make the optical engine 20 be inclined upward and backward. The optical engine 20 is, as described above, classified into a CRT type, an LCD type, a DLP type, etc. Hereinafter, the description will be given with regard to the projection television 1 comprising the optical engine 20 of the CRT type by way of an example.

The casing 10 comprises a front casing 11 to support the screen 3 and a rear casing 13 provided in a rear side the front casing 11.

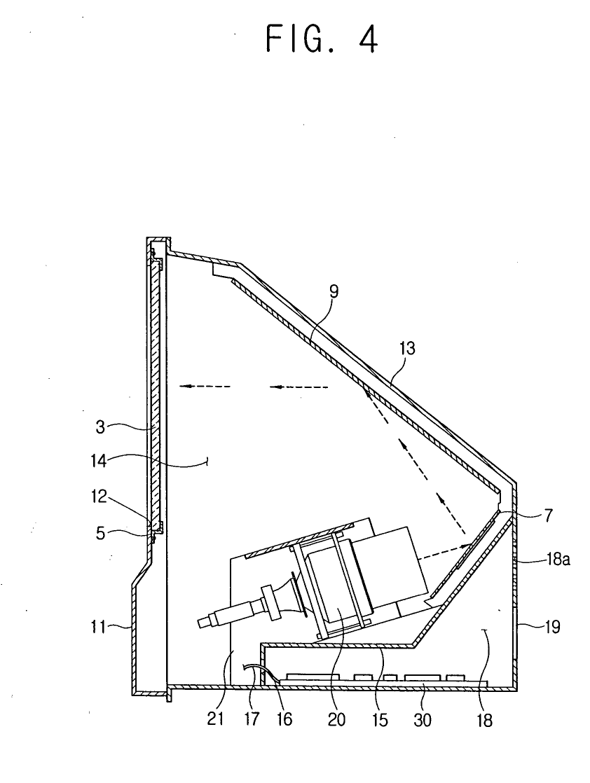

The front casing 11 is provided in front of the screen 3 and supports an edge of the screen 3. On the front casing 11 is provided an opening 12 to expose the screen 3. The front casing 11 is coupled to a screen bracket 5 (FIG. 4), which is provided in a rear side of the screen 3 to support a rear edge of the screen 3, by a screw, etc., to support the screen 3.

The rear casing 13 is coupled to the front casing 11 by a screw, etc. On an inside of the rear casing 13 are mounted the first reflecting mirror 7 and the second reflecting mirror 9. In the lower portion of the rear casing 13 is provided a circuit accommodator 18 to accommodate the circuit 30 controlling the optical engine 20.

A partitioning wall 15 separates the circuit accommodator 18 from an inner space 14 formed in the front casing 11 and the rear casing 13. The circuit accommodator 18 includes an opening at a rear portion of the rear casing 18, and an accommodator cover 19 is connected to the rear casing 13 and provided to open and close the opening. At an upper and rear part of the circuit accommodator 18 is formed an air vent 18a to discharge air heated by the circuit 30.

At the partitioning wall 15 is formed a cable passing hole 16 to pass therethrough a cable 17 connecting the circuit 30 accommodated in the circuit accommodator 18 to the optical engine 20. The cable passing hole 16 has such a size that the cable 17 may pass. The circuit accommodator 18 and the inner space 14 accommodating the optical engine 20 is partitioned by the partitioning wall 15 so that heat of a high temperature generated from the optical engine 20 is prevented from being transmitted to the circuit 30, thereby preventing a malfunction of the circuit 30.

The screen 3 displays the image by the image beam projected from the optical engine 20. The screen 3 may comprise lenses shaped like a plate, such as a lenticular lens and a fresnel lens, etc., and a sun-screen, etc., which is employed for protecting the lenses. The screen 3 is coupled to a rear side of the front casing 11 by the screen bracket 5.

The first reflecting mirror 7 shaped like a plate is mounted on a lower portion of the rear casing 13 to reflect the image beam from the optical engine 20. The first reflecting mirror 7 is smaller in size than the second reflecting mirror 9 and is provided under the second reflecting mirror 9. The first reflecting mirror 7 is inclined such that a lower portion of the first reflecting mirror 7 is projected frontward so as to reflect the image beam projected from the optical engine 20 toward the second reflecting mirror 9.

The second reflecting mirror 9 is shaped like a plate and provided at an upper portion of the rear casing 13 so as to reflect the image beam reflected from the first reflecting mirror 7 toward the screen 3. The second reflecting mirror 9 is larger in size than the first reflecting mirror 7 and provided above the first reflecting mirror 7. The second reflecting mirror 9 is inclined such that an upper portion thereof is projected frontward so as to reflect the image beam reflected from the first reflecting mirror 7 toward the screen 3.

With this configuration, operating processes of the projection television according to the present general inventive concept will be described as follows.

First, when power is supplied to the optical engine 20 and the circuit 30, the circuit 30 controls the optical engine 20 to project the image beam toward the first reflecting mirror 7. Then, the first reflecting mirror 7 reflects the image beam from the optical engine 20 toward the second reflecting mirror 9, and then the second reflecting mirror 9 repeatedly reflects the image beam from the first reflecting mirror 7 toward the screen 3 so that the screen 3 displays the image thereon.

As shown in FIG. 4, the screen 3 may be disposed on a first side of the casing 10 to be parallel to a first line, and the optical engine 20 may be disposed to project the image beam along a first optical path having a first angle with a second line perpendicular to the first line. The first reflecting mirror 7 may reflect the image beam projected from the optical engine 20 along the second optical path having a second angle with the first optical path, and the second reflecting mirror 9 may reflect the image beam from the first reflecting mirror 7 toward the screen 3 along a third optical path having a third angle with the second optical path. The first angle and the second angle may be equal to or less than 90° while the third angle is greater than 90°. It is possible that the first angle is less than 30°. The optical engine 20 may comprise a first end facing the first reflecting mirror 7 to project the image beam toward the first reflecting mirror 7, and a second end facing the screen 3, and the first and second ends are disposed on the first optical path.

As described above, the projection television 1 according to the present general inventive concept projects the image beam from the optical engine 20 to the screen 3 through the first reflecting mirror 7 and the second reflecting mirror 9 so that a volume thereof may be decreased. Further, the projection television 1 according to the present general inventive concept comprises the first reflecting mirror 7 and the second reflecting mirror 9 at a rear portion thereof so that a height of the projection television 1 becomes relatively low compared with a conventional projection television comprising a mirror at a lower portion thereof. Also, the projection television 1 according to the present general inventive concept comprises the first reflecting mirror 7 and the second reflecting mirror 9 on the rear casing 13 as a pair so that the configuration thereof becomes relatively simple compared with another conventional projection television comprising three mirrors at various positions thereof. In addition, because the optical engine 20 is provided backward, manufacturing thereof becomes simplified so that the configuration thereof is provided to facilitate the manufacturing of the same.

Although a few embodiments of the present invention have been shown and described, it will be appreciated by those skilled in the art that changes may be made in these embodiments without departing from the principles and spirit of the invention, the scope of which is defined in the appended claims and their equivalents.

What is claimed is:

1. A projection television comprising:
a screen;
a casing to support the screen;
an optical engine coupled to the casing to project an image beam;
a first reflecting mirror provided in a rear portion of the screen so as to reflect the image beam projected from the optical engine; and
a second reflecting mirror provided above the first reflecting mirror so as to reflect the image beam reflected from the first reflecting mirror toward the screen.

2. The projection television according to claim 1, wherein the casing comprises a front casing to support the screen and a rear casing provided in a rear portion of the first casing, the first reflecting mirror is provided at a lower portion of the rear casing, and the second reflecting mirror is provided at an upper portion of the rear casing.

3. The projection television according to claim 1, wherein the first reflecting mirror is smaller in size than the second reflecting mirror, is shaped like a plate, and is inclined such that a lower portion thereof is projected frontward.

4. The projection television according to claim 1, further comprising:
an engine bracket to support the optical engine such that the optical engine is inclined upward and backward to project the image beam toward the first reflecting mirror.

5. The projection television according to claim 1, further comprising:
a circuit to control the optical engine to project the image beam,
wherein the casing comprises a front casing to support the screen, a rear casing coupled to the front casing to provide a space with the front casing to accommodate the optical engine, and a partition formed in the space of the casing to separate the optical engine from the circuit.

6. The projection television according to claim 5, wherein the partition comprises a first portion perpendicular to the screen, and a second portion extended from the first portion toward the rear casing and inclined upward with respect to the first portion to have an angle with the first portion, and the angle is equal to or less than 60°.

7. The projection television according to claim 5, wherein the first reflecting mirror is disposed on the second portion of the partition.

8. The projection television according to claim 5, wherein the partition partitions the space into an inside in which the optical engine and the first and second reflecting mirrors are disposed, and a circuit accommodator in which the circuit is disposed.

9. The projection television according to claim 8, wherein the partition comprises a cable passing hole through which a cable passed to connect the circuit to the optical engine.

10. The projection television according to claim 8, wherein the rear casing comprises an opening through which the circuit accommodator communicates with an outside of the casing, so that the circuit is cooled down.

11. The projection television according to claim 10, wherein the rear casing comprises an accommodator cover to cover the opening when the circuit is disposed in the circuit accommodator.

12. A projection television comprising:
a casing;
a screen disposed on a first side of the casing to be parallel to a first line;
an optical engine disposed to project an image beam along a first optical path having a first angle with a second line perpendicular to the first line;
a first reflecting mirror to reflect the image beam projected from the optical engine along a second optical path having a second angle with the first optical path; and
a second reflecting mirror to reflect the image beam from the first reflecting mirror toward the screen along a third optical path having a third angle with the second optical path.

13. The projection television according to claim 12, wherein the first angle is less than 30°.

14. The projection television according to claim 12, wherein the optical engine comprises a first end facing the first reflecting mirror to project the image beam toward the first reflecting mirror, and a second end facing the screen, and the first and second ends are disposed on the first optical path.

15. The projection television according to claim 12, wherein the second angle is equal to or less than 90°.

16. The projection television according to claim 12, wherein the third angle is greater than 90°.

17. The projection television according to claim 12, wherein the optical engine is disposed in a space between the screen and the first reflecting mirror.
